(19) United States
(12) Patent Application Publication
(10) Pub. No.: US 2026/0103044 A1
(43) Pub. Date: Apr. 16, 2026

(54) VEHICULAR TEMPERATURE CONTROL SYSTEM

(71) Applicant: Magna Electronics Inc., Auburn Hills, MI (US)

(72) Inventor: Bishnu Raveendran, Rochester, MI (US)

(21) Appl. No.: 19/338,125

(22) Filed: Sep. 24, 2025

Related U.S. Application Data
(60) Provisional application No. 63/705,637, filed on Oct. 10, 2024.

(51) Int. Cl. B60H 1/00; B60H 1/24; B60H 1/26

(52) U.S. Cl. CPC B60H 1/00849; B60H 1/00564; B60H 1/00764; B60H 1/00785; B60H 1/00807; B60H 1/245; B60H 1/262

(57) ABSTRACT

A vehicular control system includes a vent structure disposed at a vehicle and having an inlet configured to receive airflow from exterior of the vehicle, an outlet configured to direct airflow into an interior cabin of the vehicle and a conduit extending between the inlet and the outlet. The vent structure is adjustable between a closed state, where airflow is precluded from passing within the conduit between the inlet and the outlet and an opened state, where airflow is allowed to pass within the conduit from the inlet to the outlet and into the interior cabin. An actuator is electrically operable to adjust the vent structure between the closed and opened states. Based on determination that an internal temperature at the interior cabin is greater than an external temperature exterior the vehicle, the system operates the actuator to adjust the vent structure from the closed state to the opened state.

### CROSS REFERENCE TO RELATED APPLICATION

The present application claims the filing benefits of U.S. provisional application Ser. No. 63/705,637, filed Oct. 10, 2024, which is hereby incorporated herein by reference in its entirety.

### FIELD OF THE INVENTION

The present invention relates generally to a vehicular control system for a vehicle and, more particularly, to a vehicular control system that operates one or more vents at a vehicle.

### BACKGROUND OF THE INVENTION

When a vehicle is parked in a warm and/or sunny environment with a heating, ventilation and air conditioning (HVAC) system of the vehicle not operating or in an off state, a temperature within the interior cabin of the vehicle may quickly increase. This may result in damage to vehicular components within the cabin of the vehicle, pose harm to objects and occupants within the vehicle and/or cause discomfort to the occupants of the vehicle when they return to the vehicle. While the vehicle may be parked with the HVAC system operating to keep the interior cabin cool, this consumes a large amount of energy and is impractical for long periods of time. Further, while windows of the vehicle may be left open to permit airflow to cool the interior cabin, this may expose the interior cabin to environmental elements (e.g., rain, air contaminants and the like) and/or allow unauthorized access to the vehicle cabin.

### SUMMARY OF THE INVENTION

A vehicular control system includes a vent structure disposed at a vehicle equipped with the vehicular control system. The vent structure includes (i) an inlet configured to receive airflow from exterior of the vehicle, (ii) an outlet configured to direct airflow into an interior cabin of the vehicle and (iii) a conduit extending between the inlet and the outlet. For example, the inlet may be formed at a roof structure of the vehicle (e.g., along at least one side of the roof structure and generally parallel to a longitudinal axis of the vehicle) and the outlet may be formed at a headliner of the interior cabin of the vehicle. The vent structure may be continuously open or the vent structure may be adjustable between a closed state and an opened state. An actuator may be electrically operable to adjust the vent structure between the closed state and the opened state. With the vent structure in the closed state, airflow does not flow from the inlet through the conduit to the outlet. With the vent structure in the opened state, airflow flows into the conduit through the inlet and the airflow is directed from the outlet into the interior cabin of the vehicle. In some examples, the vehicular control system operates the actuator to adjust the vent structure from the closed state to the opened state based on determination that an internal temperature at the interior cabin of the vehicle is greater than an external temperature exterior the vehicle. Thus, the vehicular control system provides passive cooling to the interior cabin of the vehicle (e.g., when the vehicle is parked and an HVAC system of the vehicle is not operating to actively blow and/or cool airflow into the cabin of the vehicle).

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular control system that opens and closes vents at an upper portion of the vehicle;

FIG. 2 is a schematic diagram of vent structure at the roof of the vehicle;

FIG. 3 is a schematic diagram of the vehicular control system;

FIG. 4 is a side view of the vehicle with airflow intake via an HVAC system of the vehicle and exhaust through the vent structure; and

FIG. 5 is a flow diagram of an example method of operating the vehicular control system.

### DESCRIPTION OF THE PREFERRED EMBODIMENTS

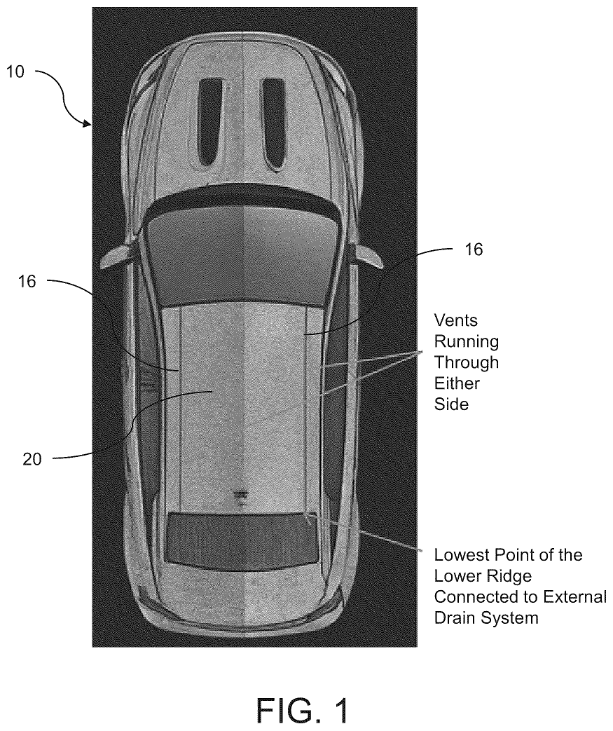

Referring now to the drawings and the illustrative embodiments depicted therein, a vehicle 10 includes a venting system or vehicular control system 12 that allows passive airflow into and/or out of an interior cabin of the vehicle 10 while preventing or precluding flow of water, dust, debris and/or other environmental contaminants into the cabin (FIG. 1). Thus, when a heating, ventilation and air conditioning (HVAC) system of the vehicle 10 is not operating to actively direct airflow within the interior cabin of the vehicle or the HVAC system is in an off state (such as when the vehicle is parked in a sunny and/or warm environment), the passive airflow into and/or out of the interior cabin reduces heating of the cabin, such as to protect objects or occupants within the vehicle and/or provide a more pleasant environment for an occupant entering the parked vehicle. As discussed further below, the venting system 12 may be operable to open and close conduits to selectively provide the passive airflow into and/or out of the vehicle, such as based on a temperature difference between the cabin of the vehicle 10 and the environment, based on detection of water exterior the vehicle, and the like.

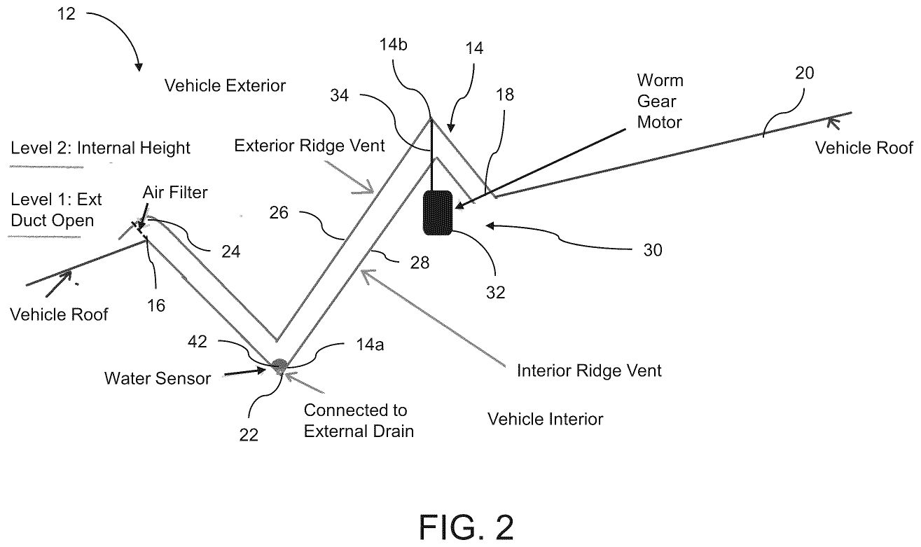

As shown in FIGS. 1 and 2, the venting system 12 includes one or more vent structures or conduits 14 extending between an inlet or opening 16 that is in communication with the environment exterior the vehicle and an outlet or opening 18 that is in communication with the interior cabin of the vehicle. The vent structure 14 extends along or is integrally formed with a roof of the vehicle 10. For example, the vent structure 14 may extend between an outer roof panel 20 of the vehicle 10 and a headliner at the interior cabin of the vehicle 10. The vent structure 14 may comprise a gap between panels of the roof and the headliner, or the vent structure 14 may comprise dedicated or separate and distinct conduits disposed between the roof and the headliner. In the illustrated example, the vehicle 10 includes two or more vent structures 14 having respective inlets 16 that extend substantially parallel to one another along opposing sides of the roof of the vehicle 10. The vent structures 14 may terminate at one or more outlets 18 inboard of the sides of the vehicle 10, such as at individual outlets 18 or a shared outlet 18 at a central region of the interior cabin. Optionally, the inlet 16 may be disposed at a forward region of the roof of the vehicle 10 (e.g., at a portion of the roof near an upper edge of the windshield) with the outlet 18 rearward of the inlet 16 (e.g., at a rearward portion of the headliner that is rearward of the inlet), or the inlet 16 may be disposed at a rearward region of the roof of the vehicle 10 (e.g., at a portion of the roof near an upper edge of the rear window) with the outlet 18 forward of the inlet 16.

The inlet 16 of the vent structure 14 may be permanently open to allow for continuous passive airflow between the environment and the interior cabin of the vehicle 10. The outlet 18 is positioned at a higher elevation than the inlet 16 to resist flow of moisture from the environment (e.g., due to rain) along the vent structure 14 and into the interior cabin. Moreover, the vent structure 14 may include a ridged or curved shape having at least one valley 14a and/or at least one peak 14b between the inlet 16 and the outlet 18 to prevent flow of moisture and allow flow of air into the cabin. Relative elevation changes of the vent structure 14 between the valley 14a and the peak 14b may be exaggerated in FIG. 2 to demonstrate the flow of moisture toward the valley 14a and the flow of air toward the peak 14b and outlet 18. Moreover, the inlet 16 may be angled or pointed at least partially downward and/or a lip may extend partially over the inlet 16 to preclude flow of moisture through the inlet 16.

Moisture that enters the vent structure 14 may collect at the valley 14a and flow through a drain 22 formed through the vent structure 14 at the valley 14a. The drain 22 may be fluidly connected, such as via a conduit or channel, to an external drainage system to allow moisture to flow exterior the vehicle (e.g., at the rear edge region of the roof, below the vehicle, and the like). Further, an air filter or mesh or grate 24 may be disposed at or near the inlet 16 to prevent or preclude dust, debris and other contaminants from passing through the vent structure 14 and into the cabin. Optionally, an adjustable vent cover may be disposed at or near the outlet 18 within the cabin of the vehicle 10 (e.g., at the headliner) to allow the vehicle occupants to adjust or restrict the flow of passive airflow into the cabin.

In other words, a continuous open vent may exist between the external atmosphere and the interior cabin. During rain or other water conditions, the water may be prevented from entering from outside to the inside by the design of the groove-like structure. The external nose of the design sits at a lower height than the internal height of the inside ridge vent. This design prevents water from leaking inside the vehicle. If water were to enter the vent, the water would start filling up the lower groove and the groove itself may be connected to the external drain to drain the water away from the structure and the groove. In case the water fills up faster than the drain can carry the water away, the external nose of the duct may be at a lower height than the maximum height of the internal ridge vent and thus water naturally drains from the external vent. Further, the air filter located at the external duct opening also hinders water, debris and other dust from entering the duct. The curved design of the outside ridge vent may further dampen the inflow of any liquids back into the interior.

Optionally, the vent structure 14 may be configured to at least partially close to restrict or prevent airflow from the inlet 16 to the outlet 18. In the illustrated example, at least a portion of the vent 14 includes an upper panel or ridge 26 and a lower panel or ridge 28. For example, the upper panel 26 may include a portion of the roof panel 20 of the vehicle 10 and the lower panel 28 may include a portion of the headliner of the vehicle 10. An actuator 30 is electrically operable to move the upper panel 26 and lower panel 28 toward one another to close or restrict the vent 14 (i.e., move the vent 14 from an opened state toward a closed state). The actuator 30 includes an electrically operable motor 32 that, when operated, moves the upper panel 26 and lower panel 28 relative to one another. For example, the motor 32 may rotate a screw or worm gear 34 to move the upper panel 26 toward the lower panel 28.

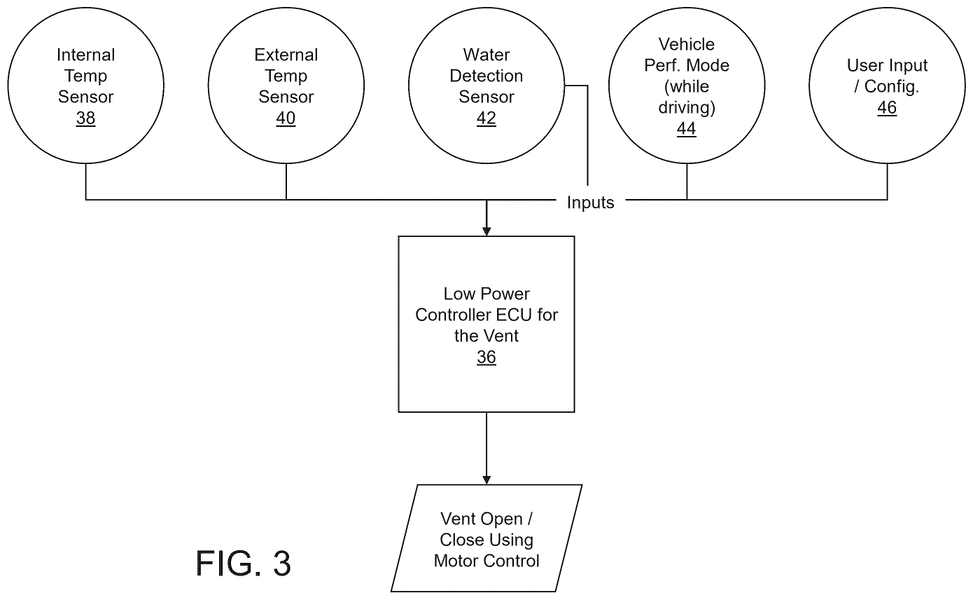

The venting system 12 further includes a controller or electronic control unit (ECU) 36 for controlling operation of the actuator 30 to open and close the vent 14 (FIG. 3). The ECU 36 may operate the actuator 30 to open and close the vent 14 based on one or more inputs. In the illustrated example, the ECU 36 receives inputs from an internal temperature sensor 38 that detects or senses a temperature of ambient air within the interior cabin of the vehicle 10, an external temperature sensor 40 that detects or senses a temperature of the ambient environment exterior the vehicle 10, a water or moisture detection sensor 42 that detects or senses moisture within the vent 14, a performance mode module 44 that controls a driving mode of the vehicle 10, and a user actuatable input 46 that receives an input from a user (such as from a driver via an input within the cabin of the vehicle or from a user associated with the vehicle via a mobile device in communication with the ECU 36). By default, the venting system 12 may maintain the vent 14 in an opened state to allow airflow into the cabin with the actuator 30 moving the vent 14 to the closed state based on signals received at the ECU 36. Optionally, the venting system 12 may maintain the vent 14 in the closed state to seal the cabin by default with the actuator 30 moving the vent 14 to the opened state based on signals received at the ECU 36.

For example, with the vehicle 10 parked and based on signals received from the internal temperature sensor 38 and the external temperature sensor 40, the system 12 may determine that the temperature within the cabin of the vehicle 10 is greater than the temperature exterior the vehicle 10 and operate the actuator 30 to move the vent 14 to the opened state. Optionally, the system 12 may move the vent 14 from the closed state to the opened state based on the temperature within the cabin of the vehicle being higher than the temperature exterior the vehicle by more than a threshold (e.g., 1 degree Fahrenheit, 5 degrees Fahrenheit, 10 degrees Fahrenheit, and the like). Similarly, based on determination that the temperature within the cabin of the vehicle 10 is below the temperature exterior the vehicle (e.g., by more than 1 degree Fahrenheit, by more than 5 degrees Fahrenheit, by more than 10 degrees Fahrenheit, and the like), the system 12 may move the vent 14 from the opened state to the closed state.

Optionally, the system 12 may maintain the vent 14 in the opened state and/or move the vent 14 to the opened state based on the temperature exterior the vehicle 10 being within a threshold range of temperatures (e.g., between about 50 degrees Fahrenheit and about 80 degrees Fahrenheit or the like). The system 12 may maintain the vent 14 in the closed state and/or move the vent 14 to the closed state based on the temperature exterior the vehicle 10 being outside the threshold range of temperatures (e.g., less than about 50 degrees Fahrenheit or greater than about 80 degrees Fahrenheit). Thus, the system 12 may only open the vent 14 to condition the interior cabin when the ambient environment is pleasant or mild.

As shown in FIG. 2, the moisture detection sensor 42 may be disposed along the vent 14, such as at or near the valley 14a of the vent 14 for detecting moisture flowing from the inlet 16. Based on detecting moisture, the system 12 may operate the actuator 30 to move the vent from the opened state to the closed state.

Moreover, the vent 14 may be transitioned between the opened state and the closed state based on a signal from the performance mode module 44 that indicates a current drive mode of the vehicle 10 (e.g., a sport mode, an eco mode or economy mode, an off road mode, an ice or snow mode, and the like). For example, based on determination that the vehicle 10 is operating in a sport mode, the vent 14 may be moved to the closed state to improve vehicle aerodynamics. Based on determination that the vehicle 10 is operating in an eco mode, the vent 14 may be moved from the closed state to the opened state to reduce the load on the HVAC system. Based on determination that the vehicle 10 is operating in an off road mode, the system 12 may move the vent 14 to the closed state to prevent dust or dirt or debris from entering the vehicle cabin. Further, the system 12 may control operation of the vent 14 between the closed state and the opened state based on the input from the user actuatable input 46 disposed within the vehicle, such as at the climate controls within the cabin of the vehicle, based on a vehicle setting, or based on an input at a mobile device in wireless connection with the vehicle 10. Thus, the vent system 12 may be operable to provide and/or restrict or prevent the passive airflow into the cabin of the vehicle 10 both during vehicle operation and when the vehicle is parked. The ECU 36 and the one or more inputs or sensors may comprise low power devices that passively monitor conditions at the vehicle for operating the system 12 to reduce power draw when the vehicle 10 is parked and not operating.

That is, in some examples involving active monitoring and adjustment, the top ridge 26 and the bottom ridge 28 may be squeezed together using the motor 32, connected via the worm gear 34 or similar mechanism. This enables the active closing and opening of the vent system 12, such as if the vehicle 10 requires a complete seal off of the interior cabin from the external environment. The water sensor 42 serves a particular role as an input to an algorithm that defines whether the vent 14 should be opened or closed. Another input that runs on the lower power ECU 36 may be the temperature sensors 38, 40. Together with these inputs from external and internal temperatures, presence of the water externally, objectively other inputs (e.g., the vehicle performance mode), the algorithm determines to open or close the vent system and may provide a full seal.

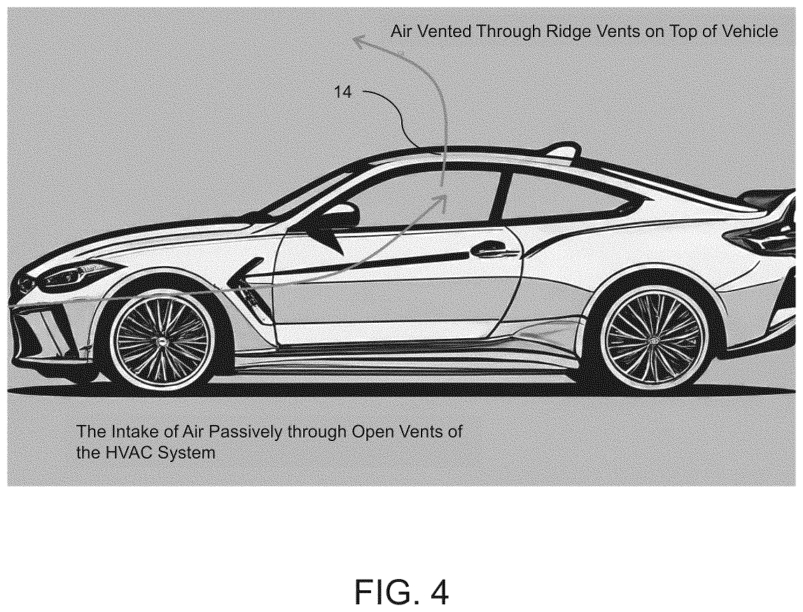

Referring to FIG. 4, in some examples the system 12 may control the HVAC system of the vehicle 10 to provide passive airflow into the cabin of the vehicle 10 with the vent 14 providing exhaust of the airflow back to the environment. That is, the system 12 may control the HVAC system to open air intake vents (e.g., at a forward region of the vehicle) so that airflow may pass into the cabin of the vehicle, with the HVAC system not operating to provide active blowing or cooling of the airflow. The airflow may exit the cabin of the vehicle 10 through the vent 14. This passive airflow through the HVAC inlets and out the vents 14 may occur when the vehicle is parked and/or when the vehicle is travelling along the road. Thus, the ECU 36 may control the HVAC system of the vehicle to open up the internal vents, such that there is a full flow of air intake from exterior of the vehicle and hot air may escape through the top vents, as described above.

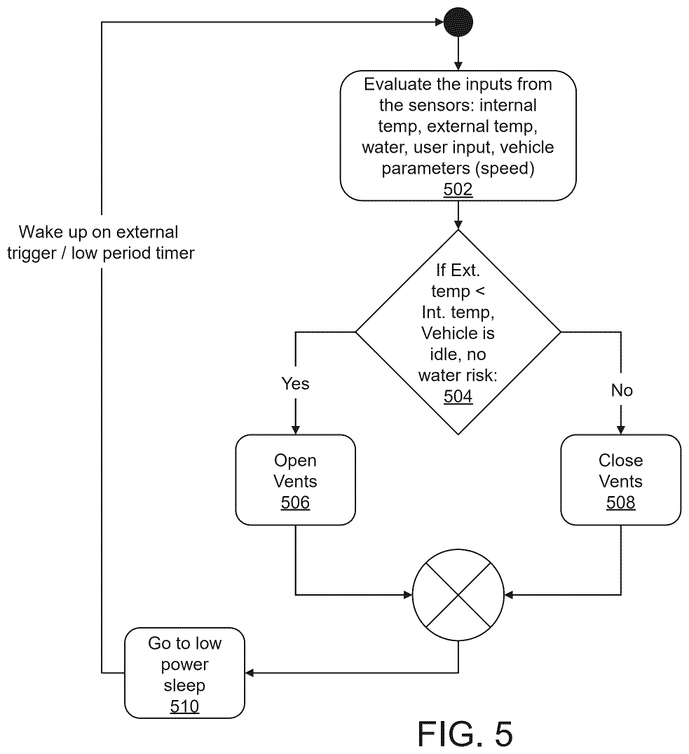

FIG. 5 depicts an example method 500 of operating the vent system 12. At operation 502, the method 500 includes processing inputs from the internal temperature sensor 38, the external temperature sensor 40, the moisture sensor 42, the user input 46, and one or more vehicle kinematic inputs (e.g., vehicle speed, vehicle location, and the like). At operation 504, the method 500 includes determining if the external temperature at the vehicle 10 is less than the internal temperature within the cabin of the vehicle 10 and determining if there is risk of moisture (e.g., based on detection or absence of detection of moisture). At operation 506, based on determining that the external temperature is less than the internal temperature and based on determining no risk of moisture, the method 500 includes moving the vents 14 to the opened state. At operation 508, based on determining that the external temperature is greater than the internal temperature and/or based on determining risk of moisture, the method 500 includes moving the vents 14 to the closed state. At operation 510, the method 500 includes maintaining the vents 14 in the current state and operating the ECU 36 in a low power sleep mode. Based on waking up the ECU 36 on an external trigger or a low period timer, the method 500 returns to operation 502.

Thus, an algorithm for the low power ECU 36 controlling the ridge vents can be elaborated to factor in a lot of different use cases and customer requirements to determine when to open and when to close the vents. For example, the internal temperature sensor 38 may be a passive/active low power temperature sensor that detects internal temperature and triggers if the temperature increases beyond a threshold or increases compared to external temperature. The rain/water sensor 42 senses if there is presence of water externally and provides a trigger if water is detected. The openable air vent slits on the vehicle roof provide a way to open and let the air exchange from the vehicle's interior cabin with external. Further, the HVAC system may be operated to open an external air stream intake, but no active cooling or blowing occurs on this mode. The air only flows passively.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular temperature control system, the vehicular temperature control system comprising:
a vent structure disposed at a vehicle equipped with the vehicular temperature control system, wherein the vent structure comprises (i) an inlet configured to receive airflow from exterior of the vehicle, (ii) an outlet configured to direct airflow into an interior cabin of the vehicle and (iii) a conduit extending between the inlet and the outlet;
wherein the vent structure is adjustable between (i) an opened state where airflow is allowed to pass within the conduit from the inlet to the outlet and into the interior cabin of the vehicle and (ii) a closed state where airflow is precluded from passing within the conduit between the inlet and the outlet;
an actuator that is electrically operable to adjust the vent structure between the opened state and the closed state; and
wherein, based at least in part on determination that an internal temperature at the interior cabin of the vehicle is greater than an external temperature exterior the vehicle, the vehicular temperature control system operates the actuator to adjust the vent structure from the closed state to the opened state.

2. The vehicular temperature control system of claim 1, wherein the outlet is disposed at a higher elevation than the inlet.

3. The vehicular temperature control system of claim 2, wherein a valley portion of the conduit between the inlet and the outlet is at a lower elevation than the inlet, and wherein a drain is connected to the conduit at the valley portion, and wherein the drain is configured to direct moisture from the conduit exterior of the vehicle.

4. The vehicular temperature control system of claim 1, wherein the conduit includes an upper portion and a lower portion, and wherein, with the vent structure in the opened state, the upper portion and the lower portion are spaced from one another to allow airflow to pass within the conduit between the upper portion and the lower portion, and wherein, with the vent structure in the closed state, the upper portion and the lower portion are moved relative to one another to restrict airflow passing within the conduit between the upper portion and the lower portion.

5. The vehicular temperature control system of claim 4, wherein the actuator comprises an electrically operable motor that, when electrically operated, causes movement of the upper portion and the lower portion relative to one another.

6. The vehicular temperature control system of claim 5, wherein the electrically operable motor, when electrically operated, drives a worm gear connected to one selected from the group consisting of (i) the upper portion and (ii) the lower portion.

7. The vehicular temperature control system of claim 1, wherein the inlet comprises an opening at a roof panel of the vehicle.

8. The vehicular temperature control system of claim 1, wherein the outlet comprises an opening at a headliner of the interior cabin of the vehicle.

9. The vehicular temperature control system of claim 1, wherein the vehicular temperature control system determines that the internal temperature at the interior cabin of the vehicle is greater than the external temperature exterior the vehicle at least in part via (i) processing of sensor data captured by an interior temperature sensor sensing temperature at the interior cabin of the vehicle and (ii) processing of sensor data captured by an exterior temperature sensor sensing temperature exterior the vehicle.

10. The vehicular temperature control system of claim 1, wherein, responsive to detecting moisture within the conduit, the vehicular temperature control system operates the actuator to adjust the vent structure from the opened state to the closed state.

11. The vehicular temperature control system of claim 1, wherein the vehicular temperature control system operates the actuator to adjust the vent structure between the closed state and the opened state based at least in part on a current drive mode of the vehicle.

12. The vehicular temperature control system of claim 11, wherein the vehicular temperature control system operates the actuator to adjust the vent structure from the closed state to the opened state based at least in part on the current drive mode of the vehicle being an economy mode, and wherein the vehicular temperature control system operates the actuator to adjust the vent structure from the opened state to the closed state based at least in part on the current drive mode of the vehicle being a sport mode.

13. The vehicular temperature control system of claim 1, wherein the vehicular temperature control system operates the actuator to adjust the vent structure between the closed state and the opened state while the vehicle is parked.

14. The vehicular temperature control system of claim 1, wherein, with the vent structure in the opened state, the vehicular temperature control system operates a heating, ventilation and air conditioning (HVAC) system of the vehicle to open air inlet vents of the HVAC system.

15. The vehicular temperature control system of claim 1, wherein the airflow comprises passive airflow.

16. The vehicular temperature control system of claim 1, wherein the vehicular temperature control system operates the actuator to adjust the vent structure from the closed state to the opened state in part responsive to the external temperature exterior the vehicle being greater than a threshold temperature.

17. The vehicular temperature control system of claim 1, wherein the vehicular temperature control system does not operate the actuator to adjust the vent structure from the closed state to the opened state in part responsive to the external temperature exterior the vehicle being less than a threshold temperature.

18. A vehicular temperature control system, the vehicular temperature control system comprising:
a vent structure disposed at a vehicle equipped with the vehicular temperature control system, wherein the vent structure comprises (i) an inlet configured to receive airflow from exterior of the vehicle, (ii) an outlet configured to direct airflow into an interior cabin of the vehicle and (iii) a conduit extending between the inlet and the outlet;
wherein the inlet comprises an opening at a forward portion of the roof panel of the vehicle;
wherein the outlet comprises an opening at a headliner of the interior cabin of the vehicle, and wherein the opening of the outlet at the headliner is rearward of the forward portion of the roof panel of the vehicle;
wherein a valley portion of the conduit is between the inlet and the outlet, and wherein the valley portion of the conduit (i) is at a lower elevation than the inlet and (ii) is at a lower elevation than the outlet, and wherein a drain is connected to the conduit at the valley portion, and wherein the drain is configured to direct moisture from the conduit exterior of the vehicle;
wherein the vent structure is adjustable between (i) an opened state where airflow is allowed to pass within the conduit from the inlet to the outlet and into the interior cabin of the vehicle and (ii) a closed state where airflow is precluded from passing within the conduit between the inlet and the outlet;
an actuator that is electrically operable to adjust the vent structure between the opened state and the closed state; and
wherein, based at least in part on determination that an internal temperature at the interior cabin of the vehicle is greater than an external temperature exterior the vehicle, the vehicular temperature control system operates the actuator to adjust the vent structure from the closed state to the opened state.

19. The vehicular temperature control system of claim 18, wherein the vehicular temperature control system operates the actuator to adjust the vent structure from the closed state to the opened state based at least in part on a current drive mode of the vehicle being an economy mode, and wherein the vehicular temperature control system operates the actuator to adjust the vent structure from the opened state to the closed state based at least in part on the current drive mode of the vehicle being a sport mode.

20. A vehicular temperature control system, the vehicular temperature control system comprising:
a vent structure disposed at a vehicle equipped with the vehicular temperature control system, wherein the vent structure comprises (i) an inlet configured to receive airflow from exterior of the vehicle, (ii) an outlet configured to direct airflow into an interior cabin of the vehicle and (iii) a conduit extending between the inlet and the outlet;
wherein the inlet comprises an opening at a roof panel of the vehicle;
wherein the outlet comprises an opening at a headliner of the interior cabin of the vehicle;
wherein the vent structure is adjustable between (i) an opened state where airflow is allowed to pass within the conduit from the inlet to the outlet and into the interior cabin of the vehicle and (ii) a closed state where airflow is precluded from passing within the conduit between the inlet and the outlet;
wherein the conduit includes an upper portion and a lower portion, and wherein, with the vent structure in the opened state, the upper portion and the lower portion are spaced from one another to allow airflow to pass within the conduit between the upper portion and the lower portion, and wherein, with the vent structure in the closed state, the upper portion and the lower portion are moved relative to one another to restrict airflow passing within the conduit between the upper portion and the lower portion;
an actuator comprising an electrically operable motor, wherein the electrically operable motor, when electrically operated to adjust the vent structure between the opened state and the closed state, causes movement of the upper portion and the lower portion relative to one another;
wherein, based at least in part on determination that an internal temperature at the interior cabin of the vehicle is greater than an external temperature exterior the vehicle, the vehicular temperature control system operates the actuator to adjust the vent structure from the closed state to the opened state; and
wherein, responsive to detecting moisture within the conduit, the vehicular temperature control system operates the actuator to adjust the vent structure from the opened state to the closed state.
